(19) United States
(12) Patent Application Publication
(10) Pub. No.: US 2018/0186108 A1
(43) Pub. Date: Jul. 5, 2018

(54) FASTENING ELEMENT, ASSEMBLY COMPRISING SAID FASTENING ELEMENT, FRONT END MODULE COMPRISING SAID FASTENING ELEMENT, AND METHOD FOR FASTENING SAID FASTENING ELEMENT

(71) Applicant: Valeo Systemes Thermiques, Le Mesnil Saint Denis (FR)

(72) Inventors: Jean-Nicolas Guyomard, Le Mesnil Saint Denis (FR); Jean-Louis Lanard, Le Mesnil Saint Denis (FR)

(73) Assignee: Valeo Systemes Thermiques, Le Mesnil Saint Denis (FR)

(21) Appl. No.: 15/738,177

(22) PCT Filed: Jun. 1, 2016
(86) PCT No.: PCT/EP2016/062421

§ 371 Date: Dec. 20, 2017

(30) Foreign Application Priority Data
Jun. 22, 2015 (FR) 1555686

(51) Int. Cl. B29C 70/84; B29C 65/70; F16B 37/00

(52) U.S. Cl. CPC B29C 70/845; B29K 2705/00; F16B 37/00; B29C 65/70

(57) ABSTRACT

Fastening element (10, 20, 30, 40) provided with a first end (16, 26, 36, 46) and a cavity (11) for receiving a complementary element therein, wherein the cavity (11) extends from the first end (16, 26) of the fastening element (10, 20, 30, 40) in an axial direction with respect to said fastening element (10, 20, 30, 40) towards a second end (17, 27, 37, 47), the fastening element (10, 20, 30, 40) having an outer wall which extends between the first end (16, 26, 36, 46) and the second end (17, 27, 37, 47), the outer wall comprising a wavy surface. The invention also relates to an assembly comprising an article and such a fastening element, and also to a front end module for a motor vehicle and to the fastening method comprising such a fastening element.

### FIELD OF THE INVENTION

The invention relates to a fastening element designed to be fastened into an object made of plastics material. The present invention also relates to an assembly comprising said object and said fastening element and to a method for fastening said fastening element, such as a nut, into said object made of plastics material.

### PRIOR ART

These days, in the automotive sector, it is known practice to produce an object from plastics material provided with a fastening element such as a nut. Such a fastening element comprises, for example, a screw thread into which a threaded screw can be fastened. In the prior art, there are a number of known methods that allow a fastening element such as a nut to be fastened into an object made of plastics material. One of these methods involves producing the object from plastics material, in which the fastening element is fastened on the external face of the object made of plastics material, this being done during a subsequent step. The fastening element may be heated and, as soon as a suitable temperature is reached, said fastening element is pushed into the object made of plastics material. Under the influence of the temperature of the fastening element, the plastics material melts and may thus accept said fastening element. Once the plastics material has returned to its initial temperature, the fastening element is permanently fastened into the object made of plastics material.

An alternative method for fastening a fastening element such as a nut in an object made of plastics material involves the use of ultrasound. The fastening material is positioned on the object made of plastics material and, through vibration obtained using ultrasound, the fastening element is embedded in the object made of plastics material.

The methods used for fastening a fastening element onto the surface of an object made of plastics material have a disadvantage in that the material of which the object made of plastics material is formed undergoes a transformation as said fastening element is being introduced onto the surface. This transformation results from the use of heat or ultrasound for fastening the fastening element to the surface.

In addition, the fastening of the fastening element onto the surface of an object made of plastics material constitutes an independent step in the obtaining of the end-product, thereby lengthening the process time and therefore representing a not-insignificant cost.

Solutions are known, in the prior art, and in these a fastening element, such as a nut, is positioned in a mold in which the object made of plastics material is obtained using a molding process. The fastening element is fastened into the object made of plastics material also using an overmolding process.

Fastening elements fastened using an overmolding process are generally conventional nuts not specially suited to said overmolding process.

FIG. 1 schematically shows a mold 1 comprising a fastening element 2 comprising a flat surface 5 forming one of the exterior faces of the fastening element 2 and designed to collaborate with a tool, such as a wrench, this element being position inside the mold 1. The fastening element 2 may be a nut provided, at its center, with a screw thread. During the overmolding process, the center of the fastening element 2 is closed off using a closed-off cylinder 3 to prevent plastic from entering the inside of the fastening element 2. FIG. 1 shows, schematically and according to the prior art, how the plastics material containing fibers is introduced into a mold 1. The presence of the fibers is indicated using the arrows 4. As shown in FIG. 1, as the plastics material containing fibers 4 is introduced during the overmolding process, said fibers 4, as they pass, come into contact with the flat surface 5 and break up under the force of the impact with said flat surface 5. Thus, the fibers 4 present in the end-product are shorter in comparison with their initial length, prior to overmolding. The product resulting from the overmolding process therefore contains fibers that no longer have their initial characteristics, this representing a disadvantage to the user.

FIG. 2 shows, schematically and according to the prior art, a configuration similar to the configuration of FIG. 1, in which the fastening element 2 is positioned inside the mold 1 in such a way as to minimize the direct impact of the fibers 4 as they are being introduced into said mold 1. Thus, the fastening element 2 comprises a flat surface 6, which is smaller in size in comparison with the size of the flat surface 5 in FIG. 1. In practice, the presence of the flat surface 6 lying in the path of the fibers 4 still causes said fibers 4 that come into contact with said flat exterior surface of the fastening element 2 to break.

FIGS. 1 and 2 show a process for the overmolding of a fastening element 2, said fastening element 2 not being optimized or especially suited to such an overmolding process intended for optimal fastening of said fastening element 2 inside the object made of plastics material.

FIG. 1 shows a fastening element 2, of conventional type, such as a nut. The fastening element 2 according to the prior art, fastened inside the surface of an object made of plastics material, is not especially suited to experiencing and deadening forces. The fastening element 2 is also not especially well suited to transferring said forces to the object made of plastics material within which the fastening element 2 is positioned. This is because the plastics material of the object offers limited physical strength with respect to the material of which the fastening element is made. As a result, the transfer of forces to the object may damage said object.

By way of example, the fastening element 2 as shown in FIGS. 1 and 2 comprises several acute angles, associated with the flat surface 5 and with the flat surface 6. If a force is applied in a radial direction with respect to the center 7, to the fastening element 2, the acute angles between the surfaces 5 and 6 are subjected to forces of great intensity. If a force is exerted, in an axial direction with respect to the center 7, on the fastening element 2, said fastening element 2 optimally transfers said force to the object made of plastics material within which the fastening element 2 is positioned. That means that when a force is exerted on the fastening element, there is a risk of damaging the plastics material of said object.

Therefore, in order to optimize said overmolding process that allows the fastening element to be fastened in an object made of plastics material, it proves necessary to modify the fastening elements and the method used for fastening the fastening element in order to improve the characteristics of the end-product comprising the assembly made up of the fastening element and of the object made of plastics material.

### SUBJECT OF THE INVENTION

The fastening element suited to being fastened in said object made of plastics material and the method for fastening said fastening element, such as a nut, in the object made of plastics material, seek to overcome the disadvantages of the fastening elements as disclosed in the prior art, by proposing an improved design of fastening element.

A first subject of the present invention relates to a fastening element provided with a first end and with a cavity to accept within it a complementary element, in which the cavity extends from the first end of the fastening element in an axial direction with respect to said fastening element towards a second end, the fastening element having an exterior wall which extends between the first and the second ends, the exterior wall comprising a wavy surface.

More particularly, the fastening element suited to be being fastened in an object made of plastics material, in which the fastening element is provided with a first end designed to be accessible when the fastening element is fastened in the object and with a cavity, such as a screw thread, in order to accept within it a complementary element such as a threaded screw, in which the cavity extends from the first end of the fastening element in an axial direction with respect to said fastening element toward a second end, the fastening element having an exterior wall which extends between the first and second ends, the exterior wall comprising a wavy surface.

Advantageously, the exterior wall comprises waves extending in the radial direction of the fastening element.

Advantageously, the exterior wall comprises waves extending in a direction that makes an acute angle with the axial direction of the fastening element.

Advantageously, the waves extend over a first part of the exterior wall in a first direction that makes an acute angle with the axial direction of the fastening element and over a second part of the exterior wall in a second direction that makes an acute angle with the axial direction of the fastening element.

Advantageously, the exterior wall is also provided with a groove.

Advantageously, the fastening element is provided with a flange.

Advantageously, the fastening element is made at least partly from metal.

A second subject of the present invention relates to an assembly formed of an object and of such a fastening element. More particularly, the object is made of plastics material.

A third subject of the present invention relates to a front end module for a motor vehicle comprising such an assembly. The object of the assembly notably corresponds to the front end module support structure designed for a motor vehicle.

A fourth subject of the present invention relates to a method for fastening a fastening element in an object, for example made of plastics material, comprising:
positioning the fastening element in a mold designed to receive a plastics material,
closing the cavity with a closure element in order to avoid plastics material entering said cavity,
filling the mold with plastics material in order to thus obtain the object made of plastics material and in order to fasten the fastening element in the plastics material.

Advantageously, the method further comprises a step of:
positioning the fastening element in the mold with the first end of the fastening element against or near the interior wall of said mold so as to position the entry to the cavity coplanar with or near the exterior surface of the object made of plastics material.

### BRIEF DESCRIPTION OF THE DRAWINGS

The object, subject matter and features of the present invention, together with the advantages thereof, will become more clearly apparent from reading the following description of preferred embodiments of a fastening element designed for an overmolding method according to the invention, which description is given with reference to the drawings in which:

FIG. 1 schematically shows the introduction of a plastics material containing fibers into a mold according to an overmolding method according to a first example of the prior art,

FIG. 2 schematically shows the introduction of a plastics material containing fibers into a mold according to an overmolding method according to a second example of the prior art,

FIG. 3 schematically shows a first embodiment of a fastening element according to the invention,

FIG. 4 schematically shows the introduction of a plastics material containing fibers according to an overmolding method using the fastening element of FIG. 3,

FIG. 5 schematically shows a perspective view of the fastening element of FIG. 3,

FIG. 6 schematically shows a second embodiment of a fastening element comprising a flange according to the invention,

FIG. 7 schematically shows the fastening element according to FIG. 6, with a first alternative form of said fastening element, and

FIG. 8 schematically shows the fastening element according to FIG. 6, with a second alternative form of said fastening element.

### DETAILED DESCRIPTION OF THE EMBODIMENTS

The detailed description hereinafter is aimed at explaining the invention in a manner that is sufficiently clear and complete, notably using examples, but must not be considered to limit the scope of the protection to the particular embodiments and examples set out hereinafter.

FIG. 3 shows, in a face-on view, a first embodiment of a fastening element 10 according to the invention. The fastening element 10 according to FIG. 3 has a shape that is designed and optimized for fastening said fastening element 10 within an object (not shown) made of plastics material. Optimized fastening of the fastening element 10 according to FIG. 3 is achieved using an overmolding method. The fastening element 10 has a wavy exterior surface, shown in a radial direction with a concave part 13 and a convex part 14.

The fastening element 10 comprises a cavity 11, more particularly a tapping or thread, in the form of a screw thread, at its center and allowing a complementary element such as a threaded screw to be fastened. The cavity 11 and the concave part 13 are a determined minimum thickness 12 apart. The cavity 11 and the convex part 14 are a maximum thickness 15 apart. The minimum thickness 12 is determined to take into consideration the mechanical strength required for use of the fastening element 10.

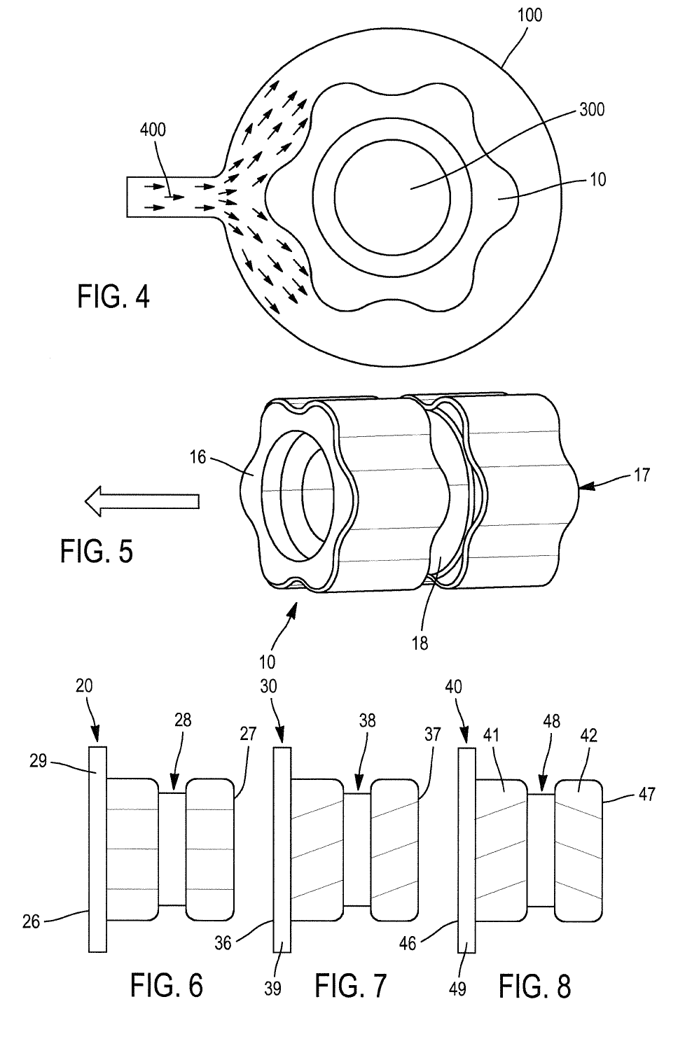

One first advantage of the embodiment of the fastening element 10 according to FIG. 3 is explained with reference to FIG. 4. FIG. 4 schematically shows the introduction of a plastics material containing fibers 400 into a mold 100 during an overmolding method. A fastening element 10 according to the invention is fastened inside said mold 100. A cylinder 300 is positioned inside the fastening element 10 so as to avoid introduction of plastics material into said fastening element 10. Because the fastening element 10 has no flat surface, the flow of the plastics material containing fibers 400 occurs without said fibers 400 impacting on a flat surface. Thus, the integrity of the fibers 400 during introduction of the plastics material into the mold 100 is guaranteed. The end-product resulting at the end of the overmolding process therefore comprises a fastening element 10 positioned in an object made of plastics material and provided with fibers 400 that have not been impaired in any way as the plastics material was introduced into the mold 100.

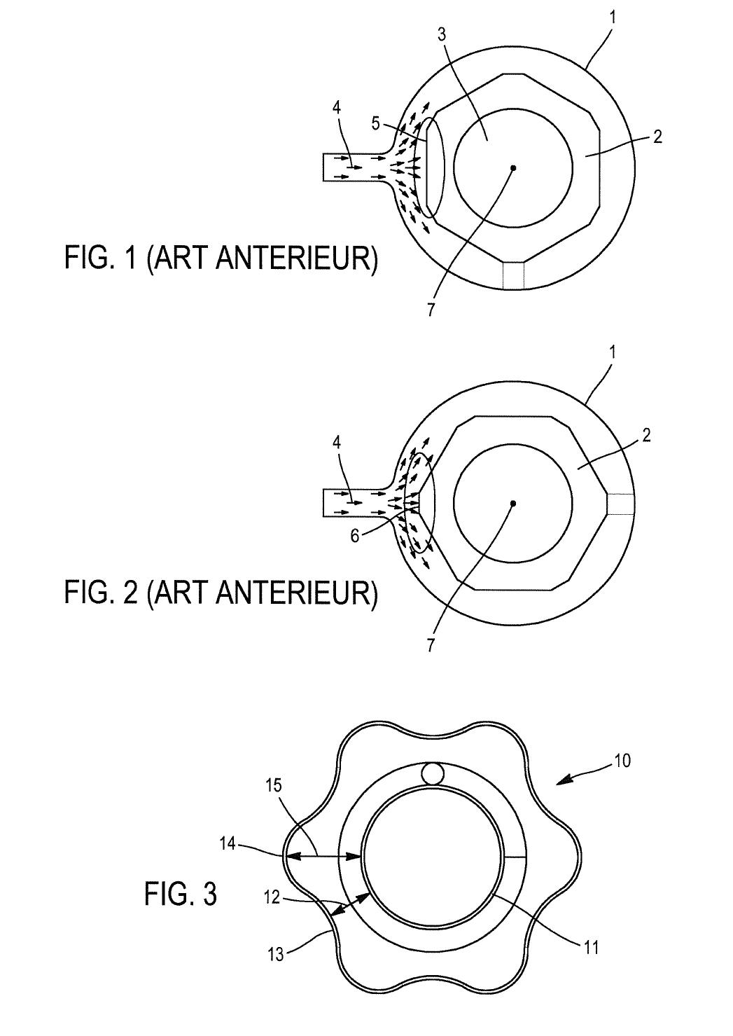

Furthermore, the transfer of the forces exerted by the fastening element 10 toward the plastics material of the object to which said fastening element 10 is fastened is optimal. After the assembly made up of the object made of plastics material and of the fastening element 10 has been obtained, said assembly offers advantages by comparison with the assemblies produced in the prior art, as shown in FIGS. 1 and 2.

According to the present invention, if a force is exerted on the fastening element 10 in the radial direction, there is no concentration of said force. Thus, the force exerted on the fastening element 10 is transferred uniformly to the plastics material. As a result, by comparison with the fastening element 2 according to the prior art, the fastening element 10 according to the invention thus offers optimal breaking strength.

FIG. 5 shows a perspective view of the fastening element 10 according to the present invention. The fastening element 10 has, at its axial ends, two flat surfaces 16, 17. The outside of the fastening element 10 is formed by an exterior wall, or wavy or striated surface, which exhibits no flat surface between said flat surfaces 16, 17 and which extends in a radial direction of the fastening element 10. The fastening element 10 is provided with a groove 18 the purpose of which is to allow a determined quantity of plastics material to penetrate. Thus, when the fastening element is fastened within the plastics material, the presence of the groove 18 improves the pull-out strength resisting the pulling of said fastening element 10 out of the object made of plastics material in which said fastening element 10 is positioned.

FIG. 6 shows a second embodiment of a fastening element 20 according to the present invention. The fastening element 20 comprises a wavy exterior surface, as described in FIGS. 3, 4, 5. The fastening element 20 is provided with a groove 28 that has the same functionalities as the groove 18 as shown in FIG. 5. In order to improve the fastening of the fastening element 20 within an object made of plastics material, said fastening element 20 is provided with a flange 29. The flange 29 makes it possible to modify the diameter along the axial length of the fastening element 20. Thus, the pull-out strength of said fastening element 20 once it has been fastened within an object made of plastics material is improved.

According to the embodiment of the fastening element 10 as shown in FIGS. 3, 4, 5 and the embodiment of the fastening element 20 as shown in FIG. 6, the waves that form the radial exterior surface of the fastening elements 10, 20 are directed in a rectilinear direction between the surfaces that form the ends 16, 17 in the case of the fastening element 10, and the ends 26, 27 in the case of the fastening element 20.

According to an alternative embodiment 30, as shown in FIG. 7, the grooves 38 make an angle with the axial direction of the fastening element 30. Because the waves are inclined by a determined angle between the surfaces that form the ends 36, 37, this improves the fastening of the fastening element 30 in the plastics material and guarantees optimal breaking strength and pullout strength.

The fastening element 30 is provided with a groove 38 that has the same functionality as the groove 18 as shown in FIG. 5. In order to improve the fastening of the fastening element 30 within the object made of plastics material, said fastening element 30 is provided with a flange 39. The flange 39 makes it possible to alter the diameter along the axial length of the fastening element 30. Thus, the pull-out strength of said fastening element 30 resisting it being pulled out once it has been fastened within an object made of plastics material is improved.

According to an alternative embodiment 40 as shown in FIG. 8, the grooves 40 make an angle with the axial direction of the fastening element 40. Because the waves are inclined at two angles between the surfaces that form the ends 46, 47, that improves the fastening of the fastening element 40 in the plastics material and guarantees optimal breaking strength and pull-out strength.

The fastening element 40 is provided with a groove 48 that has the same functionality as the groove 28 as shown in FIG. 6. In order to improve the fastening of the fastening element 40 within an object made of plastics material, said fastening element 40 is provided with a flange 49. The flange 49 makes it possible to modify the diameter along the axial length of the fastening element 40. Thus, the pull-out strength of said fastening element 40 resisting its being pulled out after it has been fastened within an object made of plastics material is improved.

1. A fastening element comprising:
a first end;
a cavity configured to accept a complementary element, wherein the cavity extends from the first end of the fastening element in an axial direction with respect to said fastening element towards a second end; and
an exterior wall which extends between the first and the second ends,
the exterior wall comprising a wavy surface.

2. The fastening element as claimed in claim 1, in which the exterior wall comprises waves extending in the radial direction of the fastening element.

3. The fastening element as claimed in claim 1, wherein the exterior wall comprises waves extending in a direction that makes an acute angle with the axial direction of the fastening element.

4. The fastening element as claimed in claim 3, wherein the waves extend over a first part of the exterior wall in a first direction that makes an acute angle with the axial direction of the fastening element and over a second part of the exterior wall in a second direction that makes an acute angle with the axial direction of the fastening element.

5. The fastening element as claimed in claim 1, in which the exterior wall is also provided with a groove.

6. The fastening element as claimed in claim 1, wherein the fastening element is provided with a flange.

7. The fastening element as claimed in claim 1, wherein the fastening element is made at least partly from metal.

8. An assembly comprising an object and a fastening element as claimed in claim 1.

9. A front end module for a motor vehicle comprising an assembly as claimed in claim 8.

10. A method for fastening a fastening element as claimed in claim 1, in an object, comprising the following steps:
positioning the fastening element in a mold designed to receive a material;
closing the cavity with a closure element; and
filling the mold with plastics material to fasten the fastening element in the plastics material within said object.
